(19) United States
(12) Patent Application Publication
(10) Pub. No.: US 2012/0026043 A1
(43) Pub. Date: Feb. 2, 2012

(54) THREE-DIMENSIONAL ARRAY ANTENNA ON A SUBSTRATE WITH ENHANCED BACKLOBE SUPPRESSION FOR MM-WAVE AUTOMOTIVE APPLICATIONS

(76) Inventors: Amin Rida, Atlanta, GA (US); Li Yang, Allen, TX (US); Alexandros Margomenos, Pasadena, CA (US); Manos Tentzeris, Atlanta, GA (US)

(21) Appl. No.: 12/845,003

(22) Filed: Jul. 28, 2010

(51) Int. Cl. H01Q 1/38

(52) U.S. Cl. 343/700 MS

(57) ABSTRACT

A multilayer antenna including a first microstrip patch positioned along a first plane, a second microstrip patch positioned along a second plane that is substantially parallel to the first plane, and a ground plane having a slot formed therein. The multilayer antenna also includes a microstrip feeding line for propagating signals through the slot in the ground plane and to the second microstrip patch and a backlobe suppression reflector for receiving some of the signals and reflecting the signals to the slot in the ground plane.

### BACKGROUND

1. Field

The invention relates to three-dimensional integrated automotive radars and methods of manufacturing the same. More particularly, the invention relates to a three-dimensional array antenna on a substrate with enhanced backlobe suppression for mm-wave automotive applications.

2. Background

Automotive radar systems are currently being provided in many luxury automobiles. Over the past few years, automotive radar systems have been used with intelligent cruise control systems to sense and adjust the automobile's speed depending on traffic conditions. Today, automotive radar systems are being used with active safety systems to monitor the surroundings of an automobile for collision avoidance. Current automotive radar systems are divided into long range (for adaptive cruise control and collision warning) and short range (for pre-crash, collision mitigation, parking aid, blind spot detection, etc.). Two or more separate radar systems, for example, a 24 GHz short range radar system and a 77 GHz long range radar system, which are typically each 15×15×15 centimeters in dimensions, are used to provide long and short range detection. Typically, the front-end (e.g., the antenna, the transmitter and the receiver) of an automotive radar system has an aperture area for the array antenna of 8 centimeters×11 centimeters and a thickness of 3 centimeters.

Prior art automotive radar systems have several drawbacks. For example, since multiple prior art radar systems are separately mounted on a vehicle, significant space is needed and can be wasteful. The cost for packaging, assembling, and mounting each radar system increases due to the additional number of radar systems. In order for each radar system to work properly, the materials placed on top of each radar system needs to be carefully selected so that the materials are RF transparent. The cost for multiple radar systems is further increased because multiple areas of RF transparency are needed on the front, sides, and rear of the vehicle. Thus, increasing the number of radar systems increases the packaging, assembly, mounting, and materials costs.

Therefore, a need exists in the art for a compact three-dimensional integrated array antenna for mm-wave automotive applications fabricated on low cost substrates.

### SUMMARY

The invention is a multilayer antenna including a first microstrip patch positioned along a first plane, a second microstrip patch positioned along a second plane that is substantially parallel to the first plane, and a ground plane having a slot formed therein. The multilayer antenna also includes a microstrip feeding line for propagating signals through the slot in the ground plane and to the second microstrip patch and a backlobe suppression reflector for receiving some of the signals and reflecting the signals to the slot in the ground plane.

### BRIEF DESCRIPTION OF THE DRAWINGS

The features, objects, and advantages of the invention will become more apparent from the detailed description set forth below when taken in conjunction with the drawings, wherein:

FIGS. 1, 2, and 3 are perspective, top, and exploded views, respectively, of a low-cost, compact radar that utilizes a three-dimensional (3-D) integrated architecture having a dual-band array made of at least two bonded layers positioned on a common ground plane according to an embodiment of the invention;

FIG. 4 is a cross-sectional view of a 3-D integrated dual-band RF front end of a radar formed on a printed circuit board (PCB) according to an embodiment of the invention;

FIG. 5 is a cross-sectional view of a 3-D integrated dual-band RF front end of a radar where the second layer is directly mounted to the PCB and a packaged T/R module is flip-chip mounted to a bottom surface of the second layer according to another embodiment of the invention;

FIGS. 6, 7, and 8 are side, top perspective, and bottom perspective views, respectively, of a multilayer antenna array having two microstrip patches, a ground plane, an opening or slot in the ground plane, a microstrip feeding line, and a backlobe suppression reflector for a 3-D integrated architecture according to an embodiment of the invention;

FIGS. 9A, 9B, and 9C show simulation graphs illustrating the improved performance of the multilayer antenna according to an embodiment of the invention;

FIG. 10 shows the layers of the antenna of FIG. 6 according to an embodiment of the invention;

FIG. 11A is a perspective view of the microstrip feeding line embedded into a 0.4 mm LCP substrate according to an embodiment of the invention;

FIG. 11B is a perspective view of the microstrip feeding line embedded into a 0.8 mm LCP substrate according to an embodiment of the invention;

FIG. 11C is a perspective view of the microstrip feeding line positioned within the cavity of the substrate according to an embodiment of the invention;

FIG. 12 is a graph showing the insertion losses of the microstrip feeding line when the microstrip feeding line is embedded in the 0.4 mm and the 0.8 mm thick LCP substrate of FIGS. 11A and 11B and is in free space as shown in FIG. 11C according to an embodiment of the invention.

FIG. 13 is a graph showing the reduction in the losses of the microstrip feeding line and the reduction of substrate or surface modes when the air cavity is formed in different sizes in the substrate according to an embodiment of the invention; and

FIG. 14 shows an antenna array having a transmit antenna (Tx) and a receive antenna (Rx) according to an embodiment of the invention.

### DETAILED DESCRIPTION

Apparatus, systems and methods that implement the embodiments of the various features of the invention will now be described with reference to the drawings. The drawings and the associated descriptions are provided to illustrate some embodiments of the invention and not to limit the scope of the invention. Throughout the drawings, reference numbers are re-used to indicate correspondence between referenced elements. For purposes of this disclosure, the term “patch” may be used synonymously with the term “antenna.”

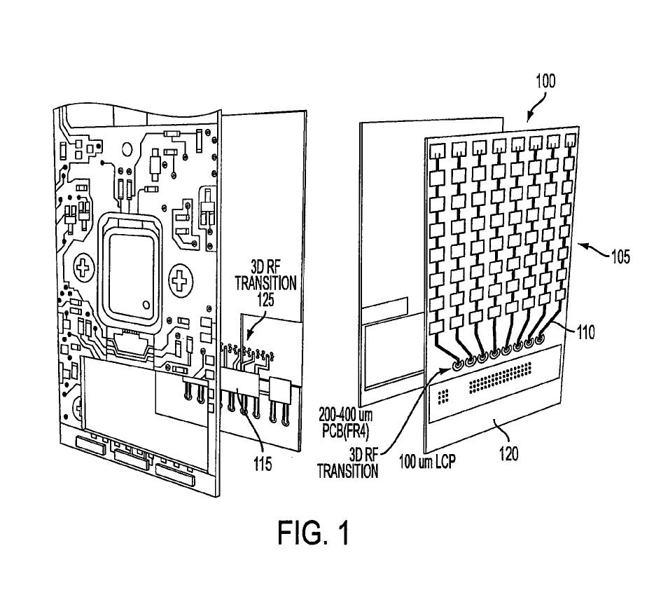

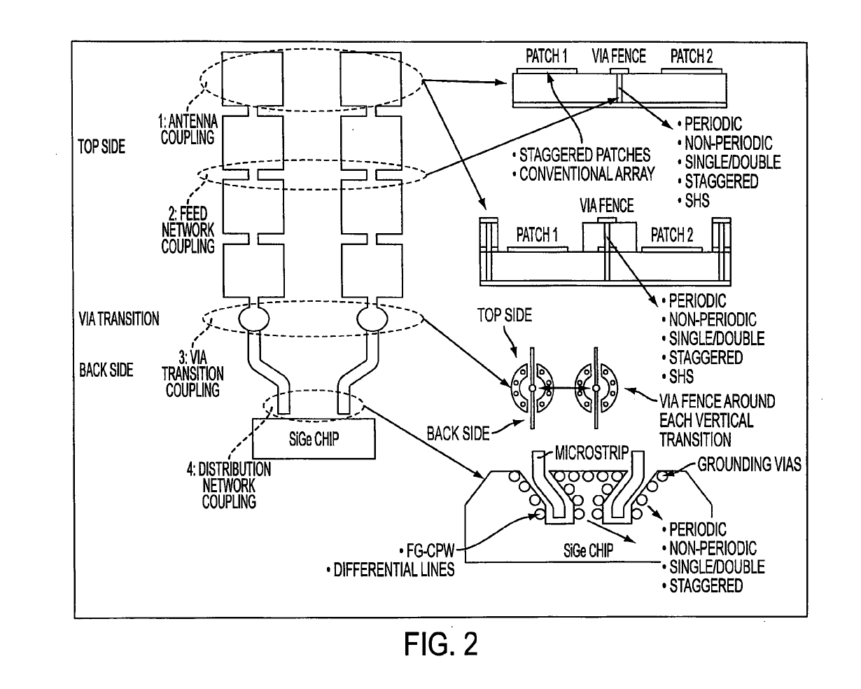

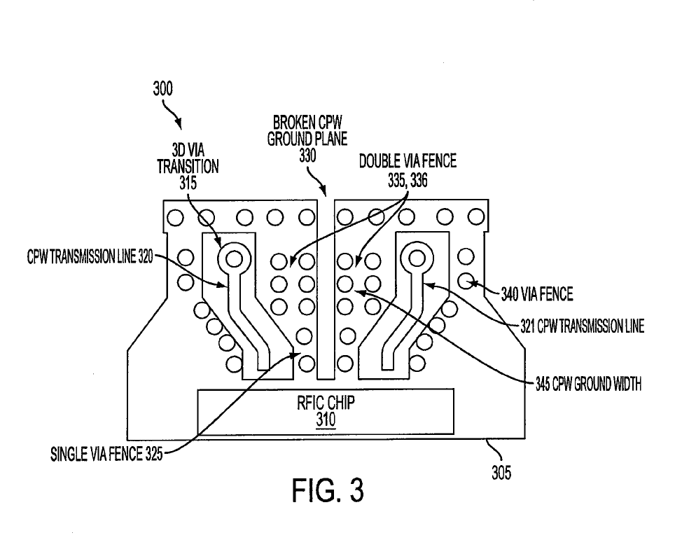

FIGS. 1, 2, and 3 are perspective, top, and exploded views, respectively, of a low-cost, compact radar 100 that utilizes a three-dimensional integrated architecture having a dual band array 105 made of at least two bonded layers 106 and 107 positioned on a common ground plane 120 according to an embodiment of the invention. The dual band array 105 includes a first layer 106 (e.g., a top or upper layer) and a second layer 107 (e.g., a lower layer). In one embodiment, the first layer 106 and the second layer 107 are bonded together and are each approximately 4 mils thick. The first layer 106 and the second layer 107 can be made of a liquid crystal polymer (LCP), a low temperature cofired ceramic (LTCC), a Parylene N dielectric, a polytetrafluoroethylene (PTFE) ceramic, a PTFE glass fiber material or any other material that can produce thin (about 2-4 mils in thickness) metallized layers which can be stacked to form multi-layer architectures. The radar 100 may be implemented using hardware, software, firmware, middleware, microcode, or any combination thereof. One or more elements can be rearranged and/or combined, and other radars can be used in place of the radar 100 while still maintaining the spirit and scope of the invention. Elements may be added to the radar 100 and removed from the radar 100 while still maintaining the spirit and scope of the invention.

The first layer 106 has a series microstrip patch array 110 for 24 GHz operation. The patch array 110 includes one or more perforated patches 111 (i.e., antennas) where each hole or opening 112 is an approximately 1.4 millimeter square opening which uncovers a 77 GHz patch 113 (i.e., an antenna) located at or on the second layer 107, which has a series microstrip patch array 115 for 77 GHz operation. The 77 GHz series microstrip patch array 115 may be printed on the second layer 107. In one embodiment, each perforated patch 111 is an approximately 3.6 millimeter square and each patch 113 is an approximately 1.2 millimeter square. The patches 111 are connected to one another via connectors 114. The size of each opening 112 is optimized to have minimum effects on the radiation performance of the patches 111 and 113.

In order to ensure no grating lobes and low side lobe level, the spacing between the first patch array 110 and the second patch array 115 is λ₀/2, where λ₀ is the free space wavelength at 24 GHz and 77 GHz, respectively. Due to the ratio between the two frequencies (77/24≈3), four 77 GHz patches 113 are placed inside or within the outer boundaries of one 24 GHz patch 111. In addition, two 77 GHz patches 113 are placed between two adjacent 24 GHz patches 111.

FIG. 4 is a cross-sectional view of a 3-D integrated dual-band RF front end of a radar formed on a printed circuit board (PCB) according to an embodiment of the invention. In one embodiment, a packaging layer 108 is formed on the PCB 109. The packaging layer 108 is made of LCP and is used for packaging the T/R module 141. For example, the packaging layer 108 may have a cavity 140 for holding the T/R module 141. In addition, IF filters may be embedded in or fabricated on the packaging layer 108. In one embodiment, the T/R module 141 may be used for both or multiple frequencies.

The second layer 107 may be formed between the 77 GHz array 113 and the T/R module ground 120. The array of second patches 113 are formed on top of or are part of the second layer 107. The microstrip feed 122 connects the array of second patches 113 to the T/R module 141. The microstrip feed 122 is transitioned through a second via 124 to the T/R module 141. The first layer 106 may be formed on top of the microstrip feed 122 and/or the second layer 107. An array of first perforated patches 111 (e.g., 24 GHz patches) are formed on top of or are part of the first layer 106. The perforations 112 on the first layer 106 allow relatively unhindered radiation to pass from the array of second patches 113 (e.g., 77 GHz patches). In one embodiment, each perforation 112 is a horn-shaped opening (i.e., a lower portion of the horn is smaller in circumference than an upper portion of the horn), which improves the radiation performance of each patch 113. The microstrip feed 121 connects the array of first patches 111 to the T/R module 141. The microstrip feed 121 is transitioned through a first via 123 to the T/R module 141 and may be formed on or may be part of the first layer 106. The first layer 106 may contain the 24 GHz series patch array 110 and the microstrip feed 121. The microstrip feed 121 and the microstrip feed 122 may include a network of feed connectors or lines.

The first layer 106 has one or more microstrip feeds 121 and the second layer 107 has one or more microstrip feeds 122. The microstrip feeds 121 and 122 are used as connections to the first and second layers 106 and 107, respectively. In one embodiment, the patch arrays 110 and 115 are comprised of microstrip patch antennas.

A plurality of chips and/or components 160 (e.g., two Silicon-Germanium (SiGe) BiCMOS chips) may be mounted on a bottom surface 119 of the PCB 109. The plurality of chips and/or components 160 may include one or more of the following: a digital signal processor (DSP), a digital clock, a temperature controller, a memory, a microprocessor, dynamic link libraries, a DC port, a data port, a voltage controlled oscillator, a PLL, etc. The plurality of chips and/or components 160 may be connected to one another via wireless links or via connectors, traces or wires on the PCB 109. The output signals 170 (e.g., digital, DC, IF or RF signals) from the T/R module 141 may be directly connected using through-vias 165 (or may be wirelessly connected) to the plurality of chips and/or components 160.

The T/R module 141 may be flip-chip bonded or mounted on a bottom surface 117 of the second layer 107. The flip-chip transition provides significantly less parasitic inductance and lower loss compared to conventional wirebonds. A plurality of thermal vias 162 are directly connected to the T/R modules 141 and pass through the first and second layers 106 and 107. The plurality of thermal vias 162 are used to remove the heat from the T/R module 141 and transfer the heat to a heat rejection area 163 that is located on a top surface 116 of the first layer 106.

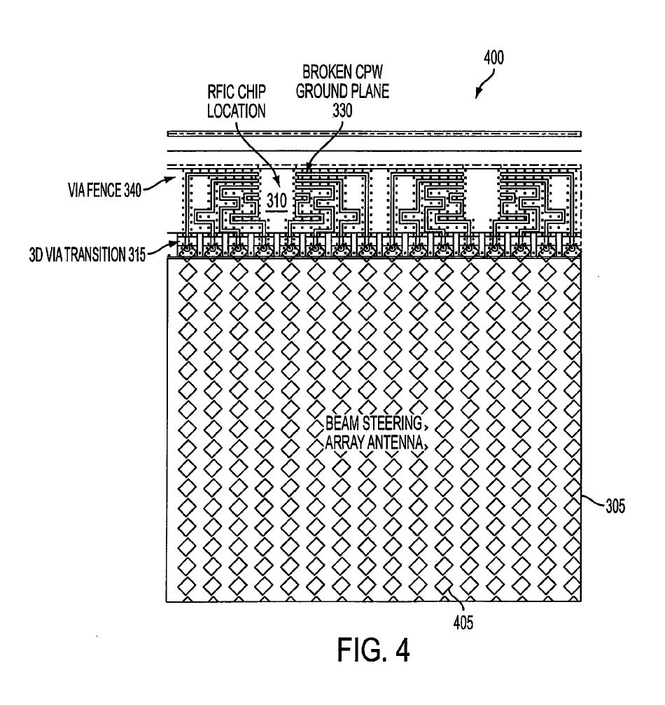

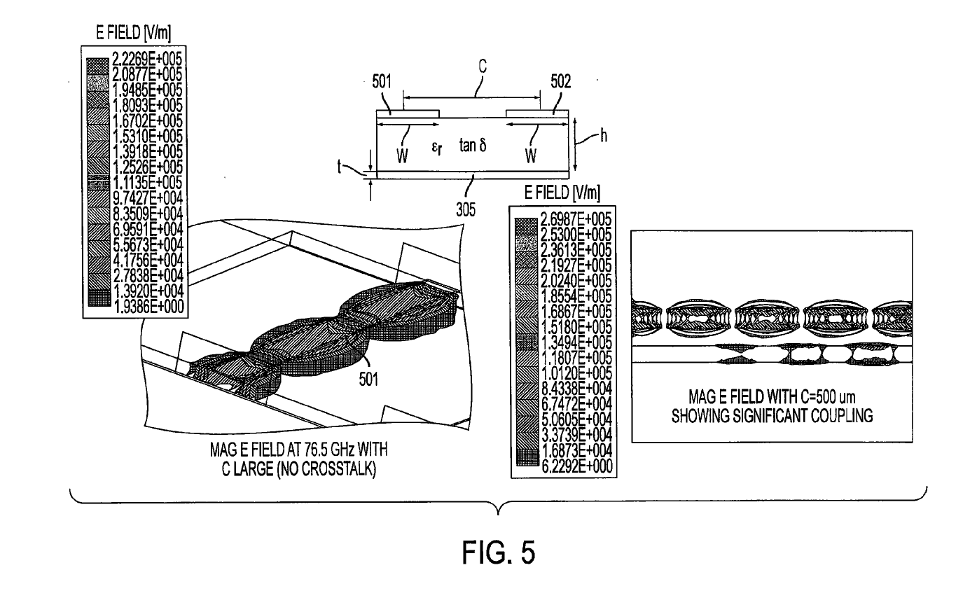

FIG. 5 is a cross-sectional view of a 3-D integrated dual-band RF front end of a radar 200 where the second layer 107 is directly mounted to the PCB 109 and a packaged T/R module 141 is flip-chip mounted to a bottom surface 117 of the second layer 107 according to another embodiment of the invention. The output signals 170 (e.g., digital, DC, IF or RF signals) from the packaged T/R module 141 may be directly connected using wirebonds 166 (or may be wirelessly connected) to the plurality of chips and/or components 160. In this embodiment, the T/R module 141 is pre-packaged so no additional LCP layer (such as 108 in FIG. 4) is needed.

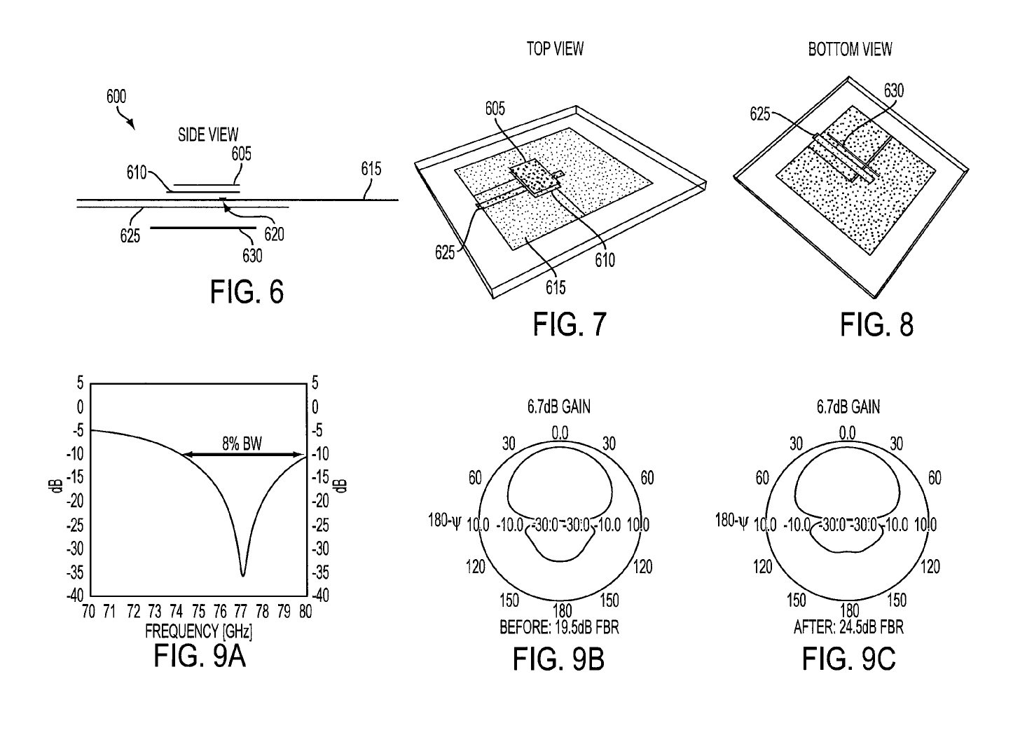

FIGS. 6, 7, and 8 are side, top perspective, and bottom perspective views, respectively, of a multilayer antenna 600 having two microstrip patches 605 and 610, a ground plane 615, an opening or slot 620 in the ground plane 615, a microstrip feeding line 625, and a backlobe suppression reflector 630 for a 3-D integrated architecture according to an embodiment of the invention. In one embodiment, the two microstrip patches 605 and 610, the ground plane 615, the microstrip feeding line 625, and the backlobe suppression reflector 630 are all spaced apart from one another and are all positioned on different parallel planes from one another. The first microstrip patch 605 may be referred to as the stacked patch 605 and the second microstrip patch 610 may be referred to as the main radiating patch 610. The first microstrip patch 605 may be positioned along a first plane and the second microstrip patch 610 may be positioned along a second plane that is substantially parallel to the first plane. In one embodiment, the opening or slot 620 is formed by an etching process. The patches shown in FIGS. 1, 2, and 3 can be configured to be similar to the patches shown in FIGS. 6, 7, and 8. The multilayer antenna 600 achieves a wider bandwidth of operation, a higher gain, and a lower backside radiation when compared to prior art antennas.

The microstrip feeding line 625 propagates signals through the opening 620 in the ground plane 615 to the main radiating patch 610, which is used to transmit the signals. The stacked patch 605 is used to direct the beams of the main radiating patch 610. In one embodiment, the two microstrip patches 605 and 610 are slot fed through the opening 620 in the ground plane 615, as opposed to a direct connection, resulting in a wider or larger bandwidth. The stacked patch 605 is positioned above or on top of the main radiating patch 610 to improve the gain and the bandwidth of the multilayer antenna array 600. In one embodiment, the stacked patch 605 is a planar version of a Yagi-Uda antenna such that the stacked patch 605 acts as a director. In one embodiment, the stacked patch 605 is attached or tacked to the main radiation patch 610.

The backlobe suppression reflector 630 is positioned below the microstrip feeding line 625 and the opening 620 in the ground plane 615. The backlobe suppression reflector 630 is designed as a resonating dipole and acts as a secondary reflector, which couples the energy that is transmitted on the backside of the antenna 600 and retransmits the energy to the front side of the antenna 600. The length of the backlobe suppression reflector 630 is approximately half a wavelength at the resonant frequency. The distance D between the main radiating patch 610 and the backlobe suppression reflector 630 has a value such that the re-transmitted energy is 180 degrees out-of-phase with the backside radiation and can therefore cancel it. The backlobe suppression reflector 630 improves the front-to-back ratio (i.e., how much energy is wasted by being transmitted to the back instead of the front) of the antenna 600 and significantly improves the aperture efficiency. The is, the aperture efficiency is improved by 60% in that the overall aperture area is reduced to a size of 5.5 cm×5.5 cm or 6 cm×6 cm. The reduced aperture area results in reduced materials and packaging and assembly costs. The backlobe suppression reflector 630 is also used to reduce or suppress radiation created by the two microstrip patches 605 and 610.

FIGS. 9A, 9B, and 9C show simulation graphs illustrating the improved performance of the multilayer antenna 600 according to an embodiment of the invention. The multilayer antenna 600 yields an 8% bandwidth, which is more than the 5% required for 77 GHz-81 GHz wideband automotive radars. The multilayer antenna 600 also yields a 6.7 dB gain and a 24.5 dB front-to-back ratio.

FIG. 10 shows the layers of the antenna 600 of FIG. 6 according to an embodiment of the invention. The antenna 600 may include substrates 607, 611, 618, and 635 (e.g., LCP) and adhesive materials 609, 614, and 616 (e.g., Pre 3098). As an example, the LCP and the Pre 3098 may be products manufactured by Rogers Corporation located in Rogers, Conn. The substrates 607, 611, 618, and 635 exhibit low loss at high frequencies, can be laminated with a copper material, can be stacked in multiple layers, and maintain good performance at wide temperature ranges (e.g., −40 degrees C. to +125 degrees C.).

The microstrip patch 605 is attached to or formed on a top surface 606 of the substrate 607. In one embodiment, the substrate 607 has a thickness of 2 mils. The microstrip patch 610 is attached to or formed on a top surface 608 of the substrate 611. In one embodiment, the substrate 611 has a thickness of 2 mils. An adhesive material 609 is placed between the substrate 607 and the substrate 611. In one embodiment, the adhesive material 609 has a thickness of 2 mils.

The ground plane 615 is attached or formed on a top surface 619 of the substrate 618. In one embodiment, the substrate 618 has a thickness of 4 mils. An adhesive material 614 is placed between the substrate 611 and the substrate 618. In one embodiment, the adhesive material 614 has a thickness of 2 mils. The microstrip feeding line 625 is attached or formed on a bottom surface of the substrate 618.

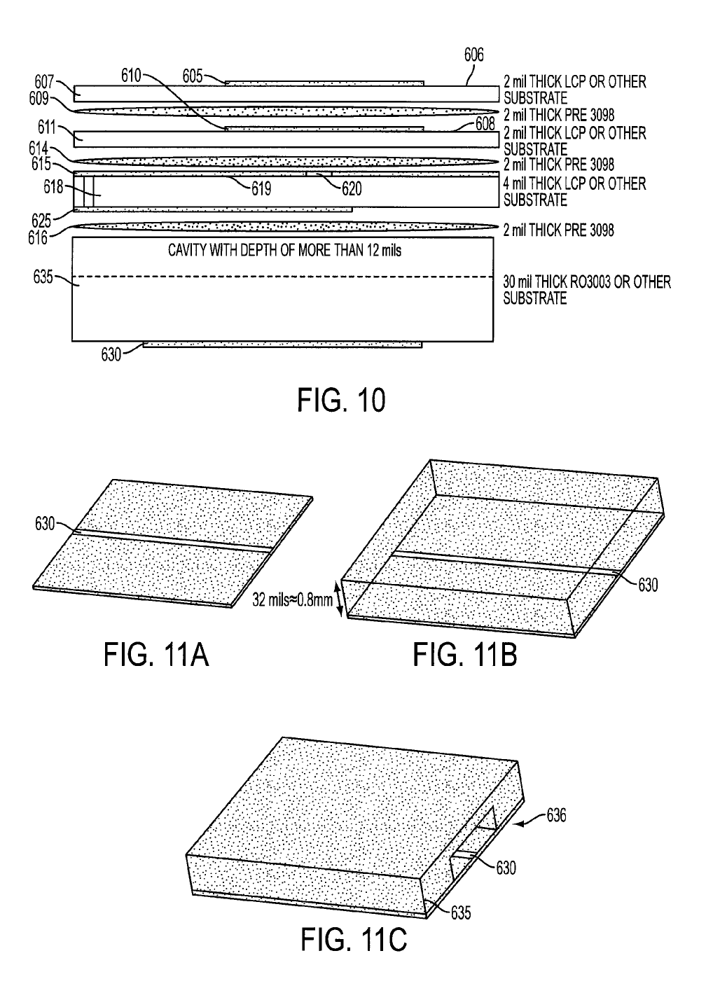

In one embodiment, the substrate 635 has a thickness of 30 mils. In one embodiment, the substrate 635 has an air cavity 636 of at least 12 mils (see also FIG. 11C). The microstrip feeding line 625 fits into the air cavity 636 and is attached to the substrate 635. An adhesive material 616 is placed between the substrate 618 and the substrate 635. In one embodiment, the adhesive material 616 has a thickness of 2 mils. The backlobe suppression reflector 630 is attached to or formed on a bottom surface of the substrate 635. The air cavity 636 reduces the losses of the microstrip feeding line 625 in order to achieve high antenna efficiency. Also, the air cavity 636 helps in suppressing substrate or surface modes that may otherwise be generated in the substrate 635.

FIG. 11A is a perspective view of the microstrip feeding line 625 embedded into a 0.4 mm LCP substrate according to an embodiment of the invention. FIG. 11B is a perspective view of the microstrip feeding line 625 embedded into a 0.8 mm LCP substrate according to an embodiment of the invention. FIG. 11C is a perspective view of the microstrip feeding line 625 positioned within the cavity 636 of the substrate 635 according to an embodiment of the invention.

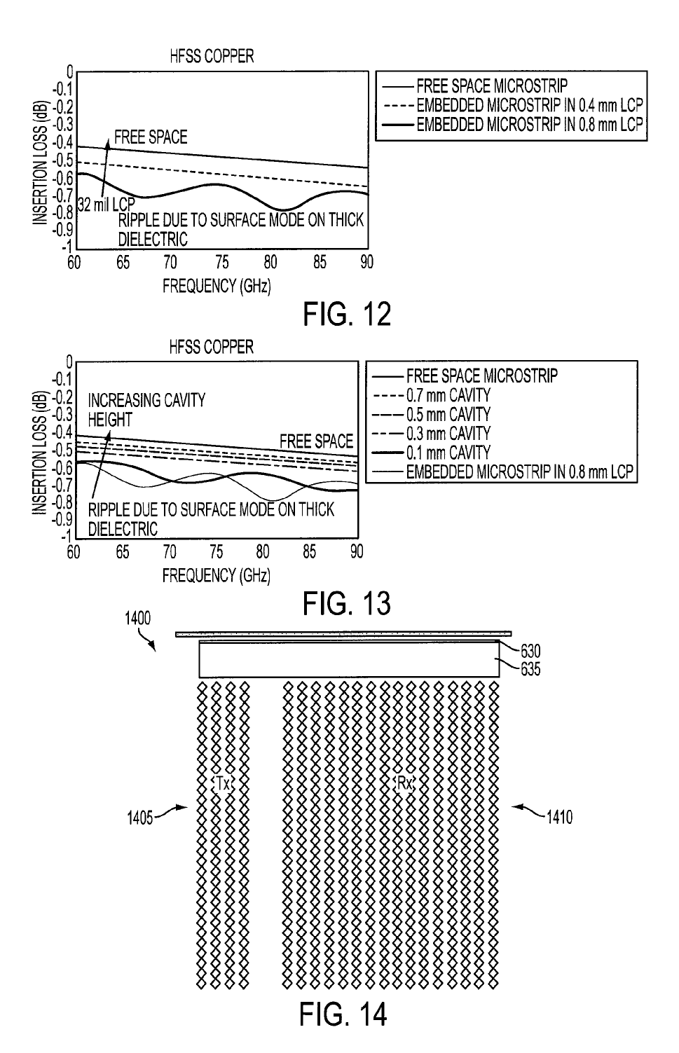

FIG. 12 is a graph showing the insertion losses of the microstrip feeding line 625 when the microstrip feeding line 625 is embedded in the 0.4 mm and the 0.8 mm thick LCP substrate of FIGS. 11A and 11B and is in free space as shown in FIG. 11C according to an embodiment of the invention. The addition of the substrate 618 over the microstrip feeding line 625 increases the losses of the microstrip feeding line 625. Furthermore, when the microstrip feeding line 625 is embedded in the 0.8 mm thick LCP substrate, a ripple as shown in FIG. 11 is created on the simulated response. The ripple is due to surface wave modes that propagate in the structure because of the thickness of the substrate 635.

FIG. 13 is a graph showing the reduction in the losses of the microstrip feeding line 625 and the reduction of substrate or surface modes when the air cavity 636 is formed in different sizes in the substrate according to an embodiment of the invention. As shown, the air cavity 636 may have a height of between 0.3 mm and 0.7 mm. The air cavity 636 is implemented in the substrate 635 to reduce the losses of the microstrip feeding line 625 and the substrate or surface modes. In one embodiment, the air cavity 636 has a height of at least 0.3 mm.

FIG. 14 shows an antenna array 1400 having a transmit antenna (Tx) 1405 and a receive antenna (Rx) 1410 according to an embodiment of the invention. In one embodiment, the transmit antenna has 4 rows of 30 antenna elements each and the receive antenna has 16 rows of 30 antenna elements each.

Those of ordinary skill would appreciate that the various illustrative logical blocks, modules, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed apparatus and methods.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A multilayer antenna comprising:
a first microstrip patch positioned along a first plane;
a second microstrip patch positioned along a second plane that is substantially parallel to the first plane;
a ground plane having a slot formed therein;
a microstrip feeding line for propagating signals through the slot in the ground plane and to the second microstrip patch; and
a backlobe suppression reflector for receiving some of the signals and reflecting the signals to the slot in the ground plane.

2. The multilayer antenna of claim 1 further comprising a substrate defining a cavity, the microstrip feeding line being positioned within the cavity of the substrate.

3. The multilayer antenna of claim 2 wherein the cavity has a height that is between 0.3 mm and 0.7 mm.

4. The multilayer antenna of claim 1 wherein the substrate has a thickness of at least 30 mils and is made of a liquid crystal polymer material.

5. The multilayer antenna of claim 1 wherein the first microstrip patch is used to direct beams from the second microstrip patch.

6. The multilayer antenna of claim 1 wherein the backlobe suppression reflector is positioned below the microstrip feeding line.

7. The multilayer antenna of claim 1 wherein the backlobe suppression reflector absorbs radiation from the first and second microstrip patches.

8. The multilayer antenna of claim 1 wherein the second microstrip patch is spaced apart from the backlobe suppression reflector by a distance D, where D has a value such that the reflected signals are approximately 180 degrees out-of-phase with the signals transmitted from the microstrip feeding line in order to provide cancellation of the signals.

9. The multilayer antenna of claim 1 wherein the backlobe suppression reflector is designed as a resonating dipole.

10. The multilayer antenna of claim 1 wherein the backlobe suppression reflector has a length that is approximately half a wavelength at a resonating frequency of the microstrip feeding line.
